(19) United States
(12) Patent Application Publication
(10) Pub. No.: US 2017/0228796 A1
(43) Pub. Date: Aug. 10, 2017

(54) System and method utilizing content marketing and ad buying systems, performance tools and automation rules for programmatic advertisement campaign management

(71) Applicant: IBUL, Toulouse (FR)

(72) Inventors: Yohann Bijaczyk, Ayguesvives (FR); Mitran Madalina, Toulouse (FR)

(21) Appl. No.: 15/136,294

(22) Filed: Apr. 22, 2016

Related U.S. Application Data
(60) Provisional application No. 62/292,346, filed on Feb. 7, 2016.

(51) Int. Cl. G06Q 30/02

(52) U.S. Cl. CPC G06Q 30/0277; G06Q 30/0276; G06Q 30/0244

(57) ABSTRACT

A system and method of creating and overseeing advertisement campaigns utilizing and synthesizing data from third party systems in a new and novel manner. An internet connected system uses modern web coding techniques, frameworks, and languages to integrate data generated by third party remote systems. The system includes a single interface that allows for utilizing and interacting with analytic data provided from and to these third party remote systems in a real time and innovative manner. The system optimizes content marketing advertisement buying through focusing on productivity gain and automated advertisement generation. The productivity gain is used to facilitate campaign and advertisement launch, and includes performance tools to scale campaigns and automation rules for programmatic campaign management.

### CROSS REFERENCE TO RELATED APPLICATIONS

This application claims the benefit of U.S. Prov. Pat. App. No. 62/292,346 filed on Feb. 7, 2016, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

The current disclosure relates to the general field of software programs that generate and control the purchasing of online advertisements, and more specifically, to a system and method of creating and overseeing advertising campaigns utilizing and synthesizing data from third party systems in a new and novel manner. Embodiments of the invention disclosed herein provide for an internet connected system using modern web coding techniques, frameworks, and languages such as Codeigniter Framework®, Jquery® and Bootstrap® to integrate data generated by third party remote systems, such as those by Taboola® and Outbrain®. A system according to the current disclosure includes a single interface that allows for utilizing and interacting with analytic data provided from and to these third party remote systems in a real time and innovative manner. The system optimizes content marketing ad buying through focusing on productivity gain and automated ad generation. The productivity gain is used to facilitate campaign/ad launch, and includes performance tools to scale campaigns and automation rules for programmatic campaign management.

Before the advent of programmatic ad buying, the decisions to buy or not buy online advertising were generally made by humans. As with many things from playing chess to flying an airplane, computers have become an integral part of many routine tasks. However, prior art systems are known to be inefficient and at times unreliable at creating and distributing ad content through third party systems.

Thus there has existed a long-felt need for a cutting edge system and method that generates unique ad content, distributes it through third party platforms, consolidates data from these third party platforms, and allocates advertising resources using the consolidated data.

### SUMMARY OF THE INVENTION

The current invention provides just such a solution by having a system and method of creating and overseeing ad campaigns utilizing and synthesizing data from third party systems in a new and novel manner. Embodiments of the invention disclosed herein provide for an internet connected system using modern web coding techniques, frameworks, and languages such as Codeigniter Framework®, Jquery® and Bootstrap® to integrate data generated by third party remote systems, such as those by Taboola® and Outbrain®. A system according to the current disclosure includes a single interface that allows for utilizing and interacting with analytic data provided from and to these third party remote systems in a real time and innovative manner. The system optimizes content marketing ad buying through focusing on productivity gain and automated ad generation. The productivity gain is used to facilitate campaign/ad launch, and includes performance tools to scale campaigns and automation rules for programmatic campaign management.

Taboola® is a content marketing web-based software program that allows content creators to place content through a “web widget”, and attempts to filter spam links before displaying the content, thereby making it more attractive to a website that is going to accept Taboola® ads on its pages.

Outbrain® is an advertising-based content discovery platform created with the goal of allowing internet publishers to, for a price, increase their web traffic by placing sponsored website links appear throughout the internet. The theory behind Outbrain® is that by placing the right ad in front of the right person, that person may make an impulse buy of a particular product. Outbrain® makes heavy use of cookies to allow it to effectively choose which viewers get which ads.

Taboola® and Outbrain® are two rival companies, and accordingly do not “work together”. Thus, the current system and method's ability to take data from multiple, unrelated systems and synthesize it into meaningful data is a unique aspect of the current disclosure.

Selected embodiments of the current disclosure provide for four basic functions. First, there is an automated ad creator, which quickly and efficiently creates multiple unique ads with relatively few inputs, for example, with drag and drop images, headlines, text. The system then pushes the ads to third party platforms such as Taboola® and Outbrain®. Second, a customizable dashboard provides a real-time view of how a client's ads are performing. Third, the system and method herein gives the ability to create rules that will govern and optimize the ad campaign such that it will run smoothly, efficiently, and automatically. The rules can be created as need be and set to be automatically triggered by the occurrence of certain events in the future. The system and method also can connect with other third party services such as Google® Analytics, AdSense®, Asana Tasks®, etc. Fourth, all of the advertising imagery is organized in one place, making re-use of it easy and efficient if needed.

It is therefore an object of the present invention to provide an effective way of harnessing the information provided by third party systems such as rival companies Taboola® and Outbrain®, and synthesize this data into a more efficient programmatic ad buying campaign.

As used herein ad refers to an advertisement; an online ad or online advertisement refers to an advertisement delivered via networked computers; an image refers to digital content or a reference to digital content that can be used to create an electronic picture viewable by a user.

Particular embodiments of the current disclosure include computer readable instructions which are stored in non-transitory computer readable storage mediums.

An embodiment of the current disclosure is a method of distributing online advertisements comprising the steps of: generating advertisements, where generating advertisements comprises the steps of accepting only one or more titles, one or more uniform resource locators (URLs), and one or more images; combining the titles, URLs, and images to create the advertisements; and providing the advertisements to a user for previewing; distributing the advertisements to a plurality of third party systems, where the third party systems provide the advertisements to end users; and managing the advertisements, where managing the advertisements comprises the steps of harvesting data from the plurality of third party systems; synthesizing the data to provide results for individual advertisements; and providing the synthesized data to the user. The step of managing the content further comprises the step of accepting a rule from the user. The step of managing the advertisements further comprises the step of providing instructions to the third party systems to disable one or more, but not all, of the advertisements based upon the rule accepted from the user. The rule comprises instructions to disable one or more advertisements based upon the occurrence of one or more future events. The third party systems provide the advertisements indirectly to end users via one or more networked computer systems. The advertisements are provided to end users through web browsers. The step of accepting only one or more titles, one or more uniform resource locators (URLs), and one or more images is provided from the user via a single web page.

Another embodiment of the current disclosure is a method of distributing content over the internet comprising the steps of: generating content, where generating content comprises the steps of accepting one or more strings, one or more uniform resource locators (URLs), and one or more images; and combining the strings, URLs, and images to create the content, where the content comprises a plurality of individual content items; distributing the content to a plurality of third party systems, where the third party systems provide the content to end users; and managing the content; where managing the content comprises the steps of harvesting data from the plurality of third party systems; synthesizing the data to provide results for the individual content items; and providing the synthesized data to the user. The step of generating content further comprises the step of providing the content to a user for previewing. The step of managing the content further comprises the step of accepting a rule from the user. The step of managing the content further comprises the step of providing instructions to the third party systems to disable one or more, but not all, of the individual content items based upon the rule accepted from the user. The rule comprises instructions to disable one or more individual content items based upon the occurrence of one or more future events. The third party systems provide the content indirectly to end users via one or more networked computer systems. The content is provided to end users through web browsers. The step of accepting only one or more strings, one or more uniform resource locators (URLs), and one or more images is provided from the user via a single web page.

An additional embodiment of the current disclosure is a system for generating, distributing, and managing advertisements distributed through third party systems comprising: an advertisement generation subsystem, where the advertisement generation subsystem comprises computer readable instructions for accepting one or more titles, one or more uniform resource locators (URLs), and one or more images; combining the titles, URLs, and images to create advertisements; and providing the advertisements to a user for previewing; an advertisement distribution subsystem, where the advertisement distribution subsystem comprises computer readable instructions for distributing the advertisements to a plurality of third party systems; an advertisement management subsystem, where the advertising management subsystem comprises computer readable instructions for harvesting data from the third party systems; synthesizing the data to provide results for individual advertisements; and providing the synthesized data to the user. The advertisement management subsystem further comprises computer readable instructions for accepting a rule from the user, and providing instructions to the third party systems to disable one or more, but not all, of the advertisements based upon the rule accepted from the user. The advertisement generation subsystem further comprises computer readable instructions for providing a single webpage through which the user can provide the one or more titles, one or more uniform resource locators (URLs), and one or more images, wherein the webpage comprises instructions for accepting inputs and creating objects, where each object comprises multiple vectors, where each vector comprises a URL, title, and image.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a flow chart showing the various steps and actions of a system and method according to selected embodiments of the current disclosure.

FIG. 2 is a flow chart showing a detailed portion of FIG. 1, including user options for interacting with the system, according to selected embodiments of the current disclosure.

FIG. 3 is a flow chart showing a detailed portion of FIG. 1, including ad generation, according to selected embodiments of the current disclosure.

FIG. 4 is a flow chart showing a detailed portion of FIG. 1, including creating and modifying campaigns, according to selected embodiments of the current disclosure.

FIG. 5 is a flow chart showing a detailed portion of FIG. 1, including creating and viewing rules, according to selected embodiments of the current disclosure.

FIG. 6 is a flow chart showing the ad generation process according to selected embodiments of the current disclosure.

FIGS. 7A, 7B, and 7C are screen shots of a user interface for generating ads according to selected embodiments of the current disclosure.

FIG. 8 is a flow chart illustrating how users interact in real time with campaign data as well as data on a sub-campaign level according to selected embodiments of the current disclosure.

FIGS. 9A and 9B are screen shots of a user interface for interacting in real time with campaign data according to selected embodiments of the current disclosure.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

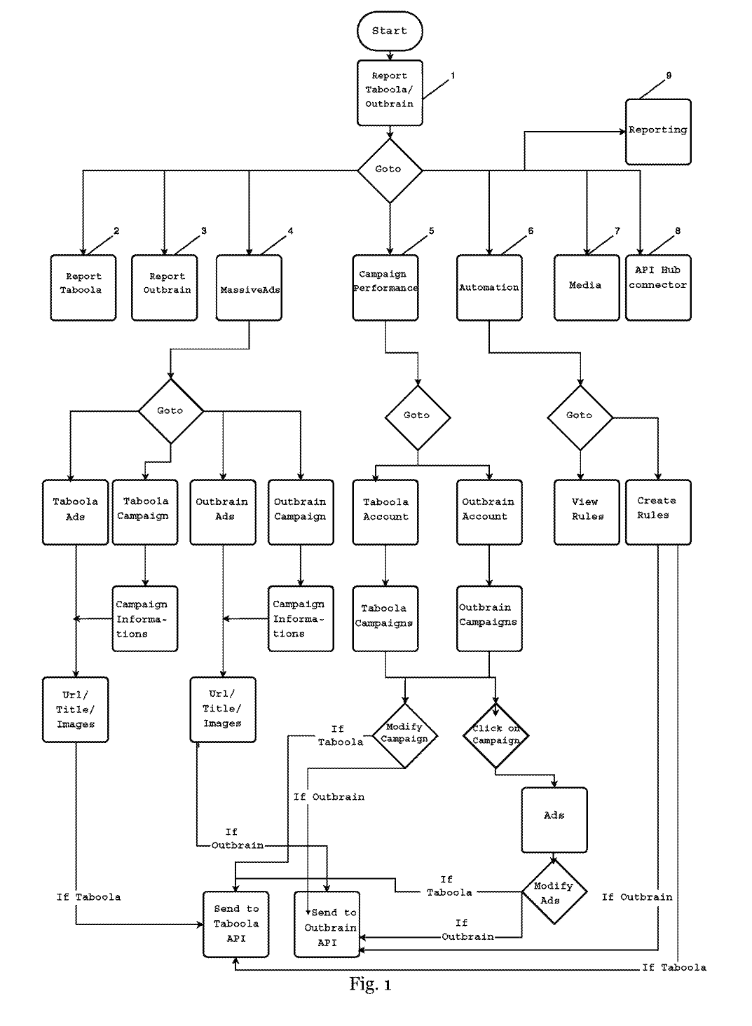

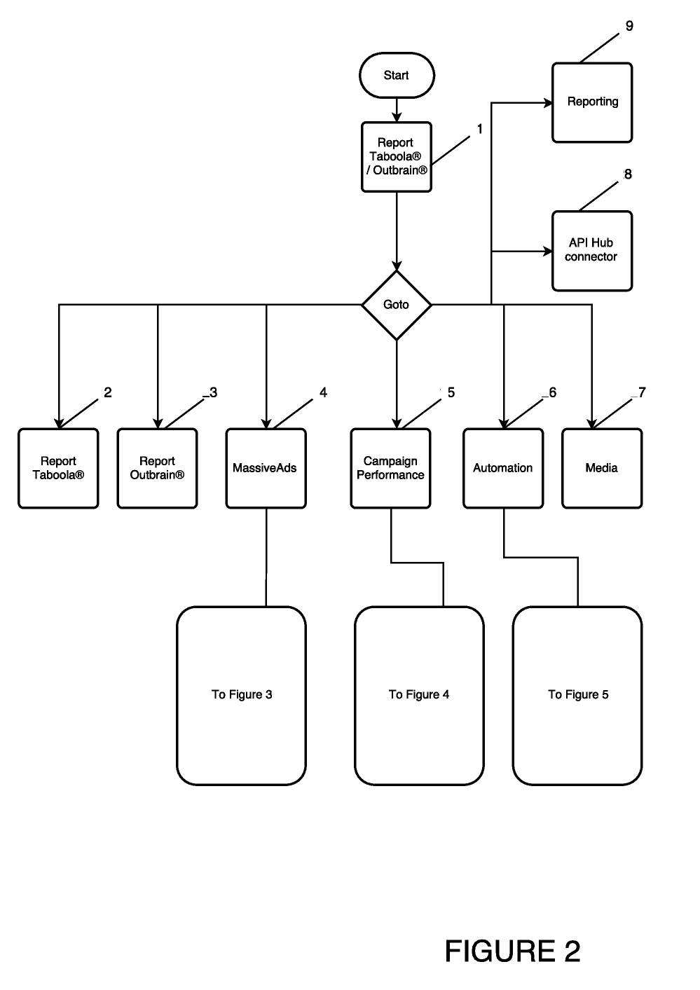

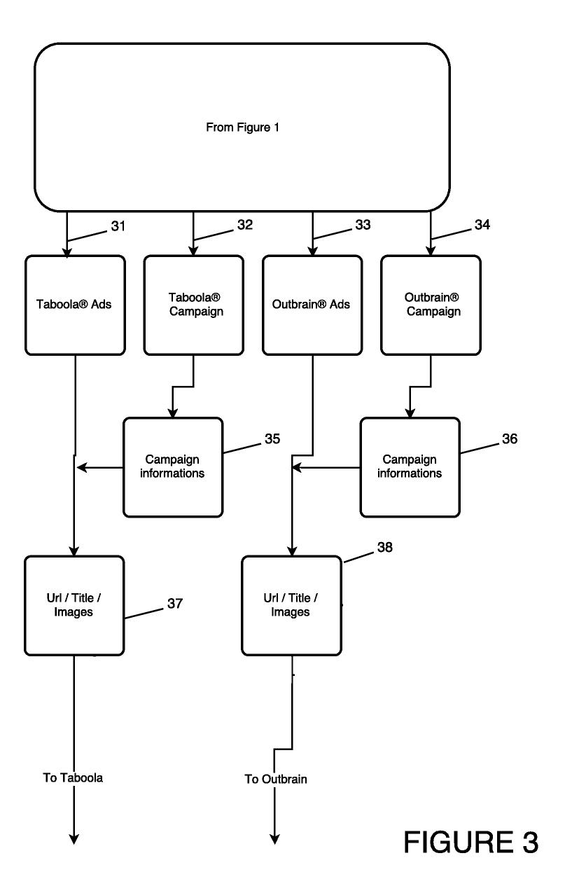

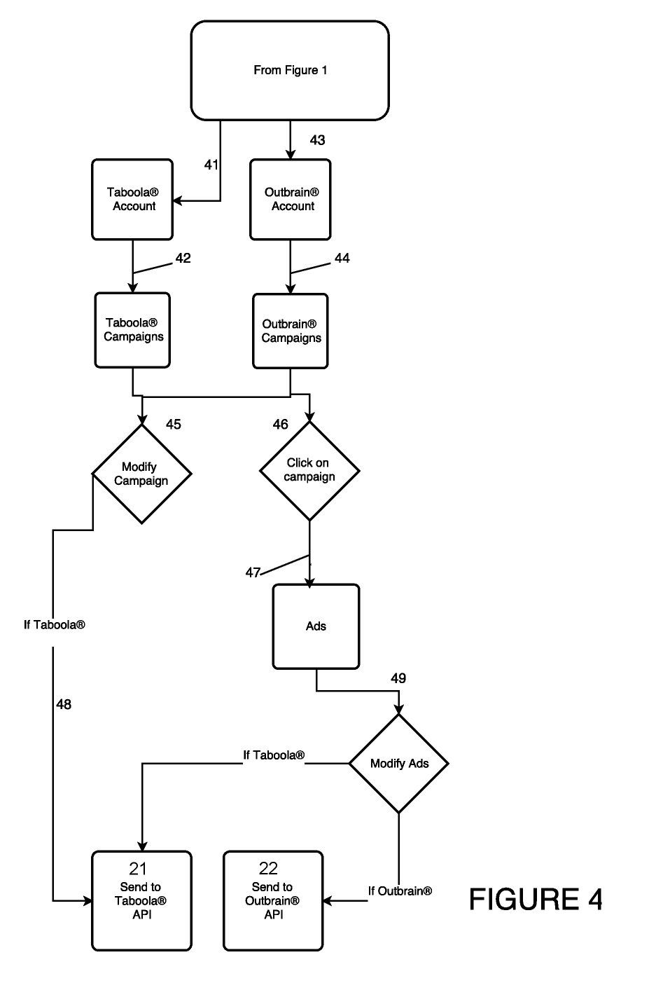

FIG. 1 is a flow chart showing the various steps and actions of a system and method according to selected embodiments of the current disclosure. The process starts by harvesting reports from third party systems such as Taboola® and Outbrain®, as shown more clearly in FIG. 2. These reports serve as the foundation for a number of components of the system and method, which are discussed in more detail below with respect to FIGS. 3 through 5.

In FIG. 1, reports are obtained from third party systems such as Taboola® and Outbrain® (this harvesting is generally referenced as 1). As mentioned previously, collecting data from these two competitors and synthesizing it into meaningful and useful data is an important aspect of the current disclosure. Upon harvesting the data 1, the data is used to prepare reports organized by third party services such as Taboola® 2 and Outbrain® 3. These reports use data obtained from third party service providers through application programming interfaces (APIs) and display chart like spend and conversion. This data is also used to spawn a massive ad campaign 4 (described more fully in FIG. 2). The massive ad campaign is monitored as described more fully in FIG. 3. FIG. 4 shows ways in which the process of ad buying can be automated 6, such that the ad campaign runs according to rules which create pre-determined actions that occur upon the occurrence of certain events or conditions. The data is also used with an API Hub 8 to interact with various media 7, such as Google ® Analytics, AdSense®, Asana Tasks®, etc. Finally, the data is also used for reporting 9 in which data is extracted from third party service APIs for a period of time, such as the last entire month, and generates charts (spend, conversion, clicks, impression, cost-per-action (CPA)) and campaigns information. The system and method herein may also include an export function, whereby data may be provided in a portable format, such as portable document format (PDF) and comma separated value (csv).

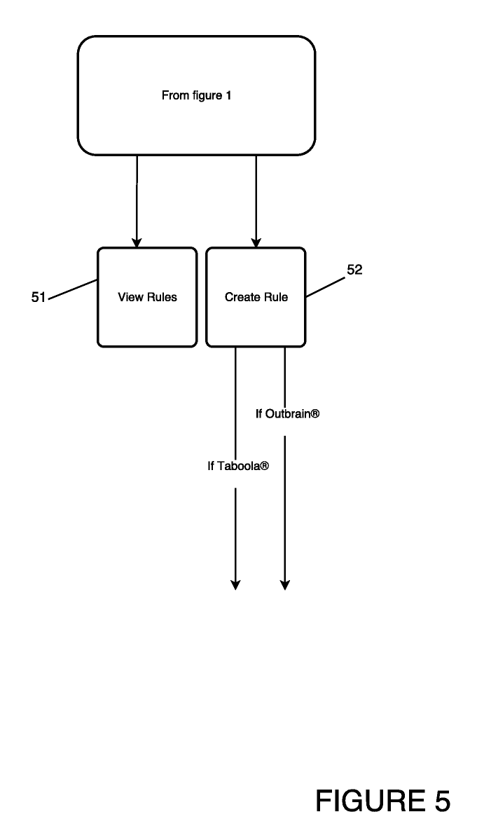

FIG. 2 is a flow chart showing a detailed portion of FIG. 1, including user options for interacting with the system, according to selected embodiments of the current disclosure. The data from FIG. 1 is used to create ads and advertising campaigns for third party systems such as Taboola® and Outbrain®. One important aspect of this invention is the method by which the invention can produce and send thousands of ads in one page. This provides a massive improvement over the existing technology that uses a step-by-step multipage process. As discussed previously, after harvesting the data from Taboola® and Outbrain®, the data is used for generating ads 4, as illustrated more fully in FIG. 3, campaign performance controls 5, as illustrated more fully in FIG. 4, and automation 6, which is more fully illustrated in FIG. 5.

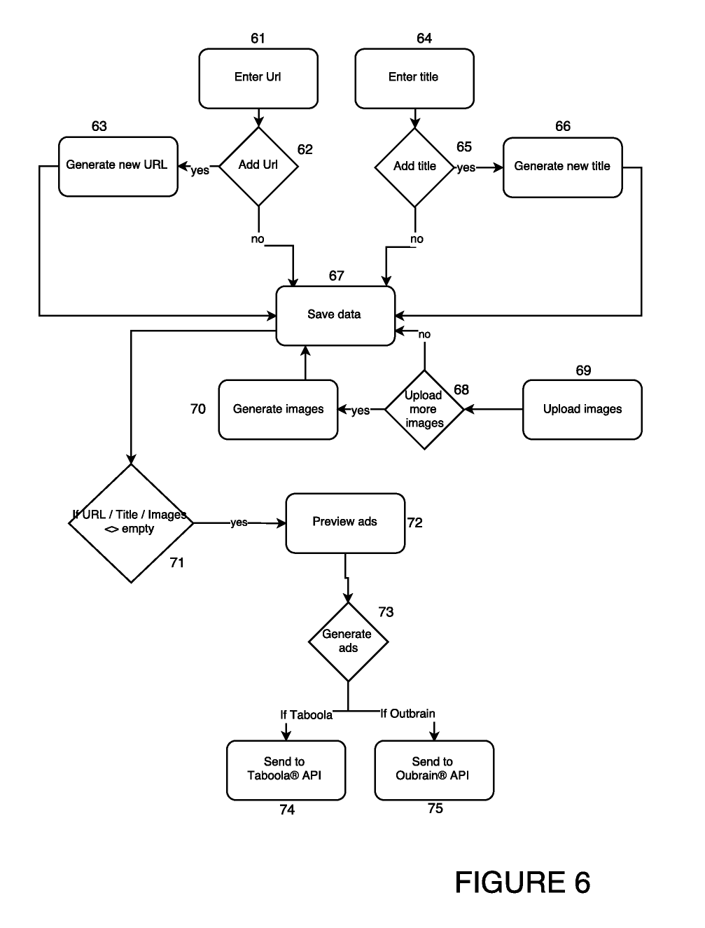

FIG. 3 is a flow chart showing a detailed portion of FIG. 1, including ad generation, according to selected embodiments of the current disclosure. Harvested data 1 from FIGS. 1 and 2 is synthesized and used to generate massive ad campaigns. Ad frameworks (31 and 33) and campaign frameworks (32 and 34) for Taboola® and Outbrain® respectively are combined with campaign information (35 and 36) to provide the foundation for generating ads (37 for Taboola® and 38 for Outbrain® respectively, discussed in more detail with regard to FIG. 6), which are then sent to Taboola® and Outbrain®. An important element in this process is the ability of the system and method to generate and send thousands of ads utilizing just one web page. The current state-of-the-art in the ad buying and creating industry is to use a step-by-step process, using multiple pages, and interacting with a single third party system. This is a relatively inefficient manner both in terms of time and resource expenditure as compared with the embodiments of the current disclosure.

In selected embodiments, the system generates a large number of ads, using a smaller number of inputs. In some embodiments, the system provides instructions to a remote system, such as a web browser of a user. These instructions accept the inputs entered by the user and create objects, all without making additional requests to the system; in other words, without loading an additional page. Each object includes multiple vectors, where each vector includes a URL, title, and image. The vectors are created by combining the different combinations of URLs, titles, and images. Using the dynamically created object, the browser can display a preview of all of the generated ads, whereby the user can add additional ads, either manually or through the submission of additional URLs, titles, and/or images. Furthermore, the user can edit or delete certain ads (vectors) from the object. If the generated ads are acceptable to the user, the object can be sent to the system, and acted upon accordingly.

FIG. 4 is a flow chart showing a detailed portion of FIG. 1, including creating and modifying campaigns, according to selected embodiments of the current disclosure. The data harvested 1 from FIG. 1 is sent to an appropriate account (41 and 43 for Taboola® and Outbrain® respectively) and turned into campaigns (42 and 44 respectively). If the ad campaign is to be sent to Taboola® 48, if can be modified 45 and subsequently sent to Taboola® 48.

The system and method herein enables a user to click on the campaign 46 to access the ads 47. This is another important element to the invention. This step allows a user of the system to directly access the ad campaign at the ad level. As mentioned previously during the discussion of FIG. 3, having all the ads on one sheet saves an incredible amount of time. The current state-of-the-art in the ad buying industry requires a human to access a page with a single ad, one at a time. The current system saves significant amounts of time as it redistributes the right data on the same page. After viewing the entire ad campaign on a single page, the user can create, modify or select ads 49, which are then sent to the Taboola® API 21 or Outbrain® API 22.

FIG. 5 is a flow chart showing a detailed portion of FIG. 1, including creating and viewing rules, according to selected embodiments of the current disclosure. After analyzing and viewing the data from FIG. 1, the system enables a user to view the current rules 51, and create rules 52, which are then sent to either Taboola® or Outbrain®. Rules help determine which ads get played when and to whom. For example, a user can create a rule through the system that the ads only be displayed during certain local times of the day.

FIG. 6 is a flow chart showing the ad generation process according to selected embodiments of the current disclosure. To create an ad, the system puts together a uniform resource locator (URL), title, and an image. These individual elements are entered into and saved by the system on a single page within the same process, thereby saving significant time over the prior art and current state-of-the-art procedures. The user of the system enters a URL 61 and a title 64. After entering the URL 61, the system attempts to add the URL 62. If this is successful, a new URL item is generated 63 and the data is saved 67. If unsuccessful, for example, if there was a network connection error or an invalid format for the entered URL, a message may be displayed to the user, and the system saves what data it can 67. After entering a title 64, the system attempts to add the title 65. If successful, the system generates a new title item 66 and the data is saved 67. If unsuccessful, for example, if there was a network connection error or a invalid format for the entered title, a message may be displayed to the user, and the system saves what data in can 67.

Users also upload images 69. The user attempts to upload more images 68. If successful, it generates image items 70 and saves the data 67. If unsuccessful, it saves what data it can 67.

As will be appreciated, the steps of entering a title, URL, and images can be repeated many times, in which case there are multiple titles, URLs, and images. After the user is finished entering the URL(s), title(s), and image(s) and the data is saved 67, the system creates a large number of combinations of URL/Title/Images 71, which can be previewed 72. In a particular embodiment, the ads are generated by creating all of the combinations of titles, URLs, and images, whereby no two ads have the same title, URL, and image. Once previewed and approved, the system generates ads 73. These ads can then be sent to third party systems such as Taboola® 74 and Outbrain® 75.

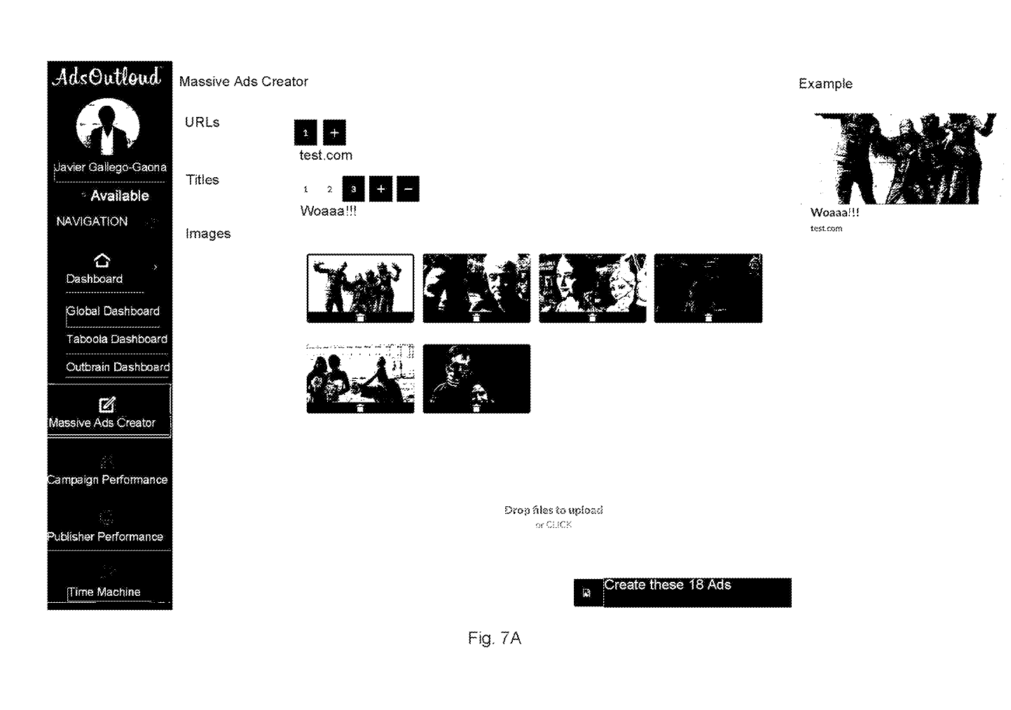

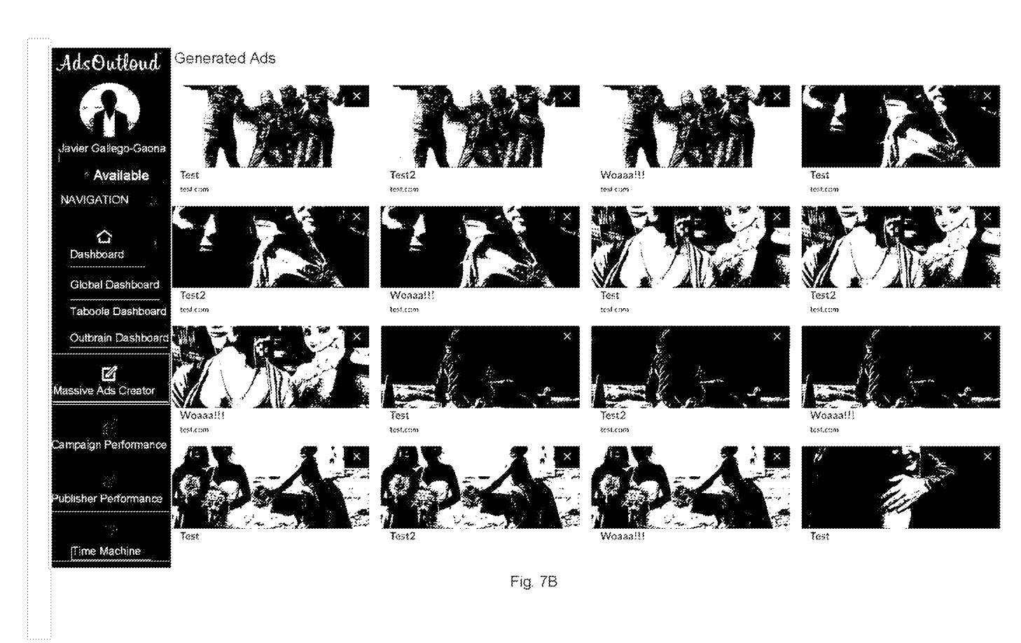

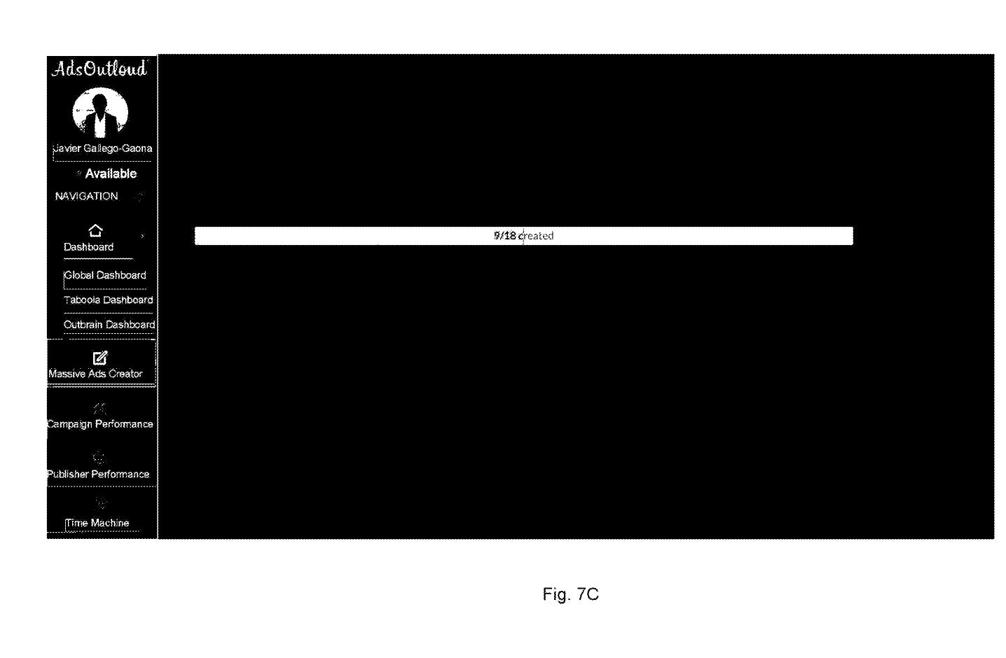

FIGS. 7A, 7B, and 7C are screen shots of a user interface for generating ads according to selected embodiments of the current disclosure. FIG. 7A shows a user interface for entering in the URL(s), title(s), and images discussed above in regard to FIG. 6. FIG. 7B shows a user interface for previewing the ads automatically generated by the system. FIG. 7C shows a user interface with a status bar of progress while automatically generating ads.

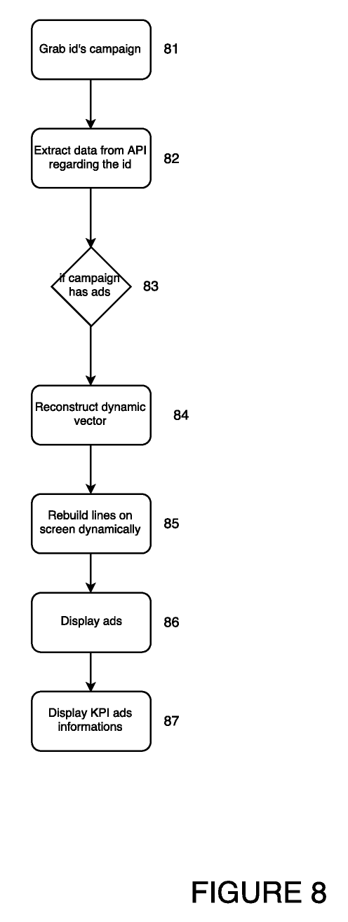

FIG. 8 is a flow chart illustrating how users interact in real time with campaign data as well as data on a sub-campaign level according to selected embodiments of the current disclosure. An approach is utilized that focusses on creating temporary objects and algorithmic/dynamic reconstruction for interacting with real time campaign data. This allows the user of the system to see the campaign data and interact with it in a real time way, as well as delve into the campaign on a sub-campaign level. The programmatic method focusses on creating temporary objects and relies on algorithmic and dynamic reconstruction to give the user greater and more efficient observatory powers and puts him/her in a significantly better position to review and revise the ad campaign if need be, compared to current methods being used in the industry. The process begins by grabbing campaign ids 81 for the respective third party system and extracting associated data from the respective API regarding the id 82. The process then determines if the campaign has ads 83 and reconstructs a dynamic vector 84. It then rebuilds lines on the screen dynamically 85, displays ads 86 and then displays the key performance indicator (KPI) for the ads 87.

The system utilizes multiple API requests to the third party systems to obtain the appropriate data. A first temporary object is created and is composed of a campaign's general data, such as status, conversions, cost-per-click (CPC), and impressions. The first temporary object may also include budget information related to the campaign, including a daily budget and click-through-rate (CTR). A second object is created and is composed of multiple ad vectors, with each vector including ad information such as status, CPC, budget, and CPA, and associated campaign. These objects are then provided by the system to the user via a web browser. Accordingly, the user is able to interact with multiple campaigns through multiple third party systems in a single interface. Furthermore, individual ads within a campaign may be updated, such as modifying the bidding or budget for an ad or campaign.

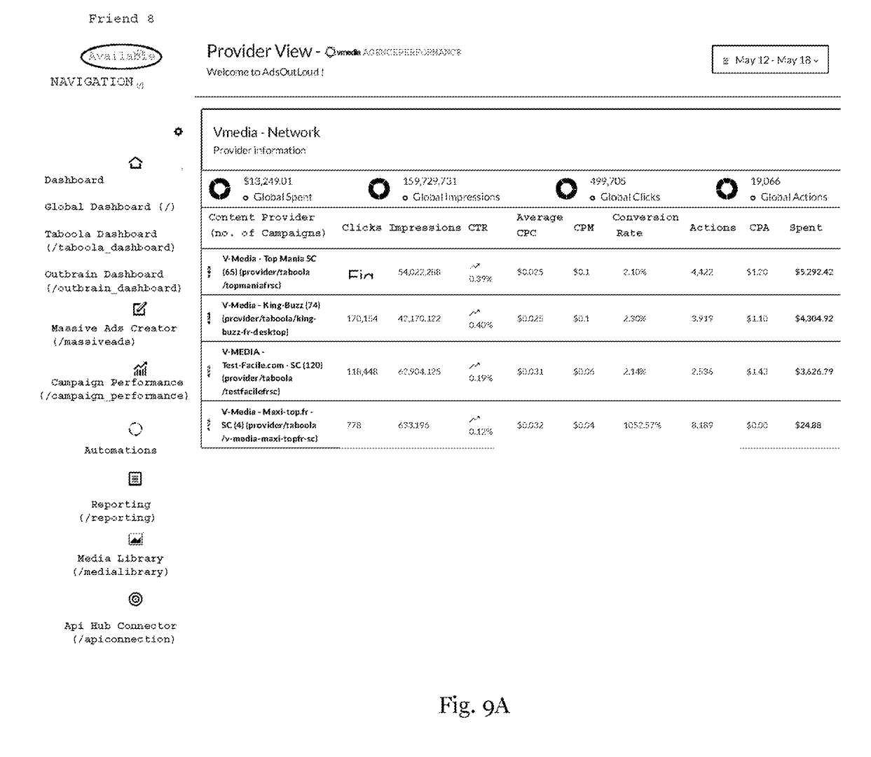

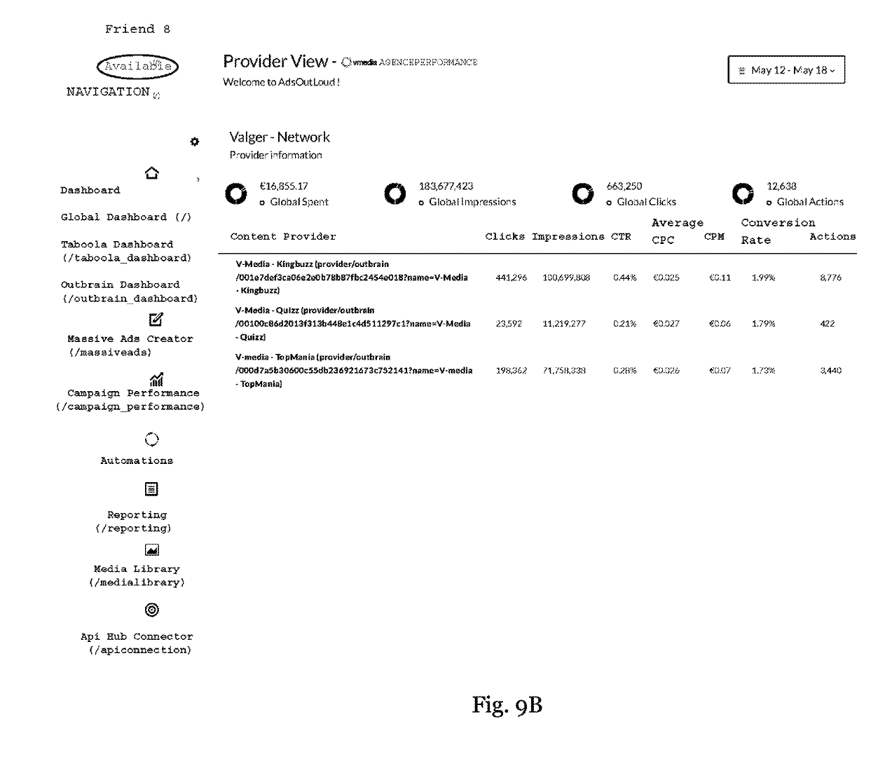

FIGS. 9A and 9B are screen shots of a user interface for interacting in real time with campaign data according to selected embodiments of the current disclosure. FIG. 9A shows campaign data for a specific campaign, with switches to turn on and off a specific ad within the campaign. As stated, rules may also be implemented to determine which ads are enabled, such as only ads that have a minimum click through rate after a set number of impressions. FIG. 9B is an alternative configuration showing a list of campaigns and their respective data.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

That which is claimed:

1. A method of distributing online advertisements comprising the steps of:
generating advertisements, where generating advertisements comprises the steps of accepting only one or more titles, one or more uniform resource locators (URLs), and one or more images; combining the titles, URLs, and images to create the advertisements; and providing the advertisements to a user for previewing;
distributing the advertisements to a plurality of third party systems, where the third party systems provide the advertisements to end users; and
managing the advertisements, where managing the advertisements comprises the steps of harvesting data from the plurality of third party systems; synthesizing the data to provide results for individual advertisements; and providing the synthesized data to the user.

2. The method of claim 1, wherein the step of managing the advertisements further comprises the step of providing instructions to the third party systems to disable one or more, but not all, of the advertisements.

3. The method of claim 1, wherein the step of managing the advertisements further comprises the step of accepting a rule from the user.

4. The method of claim 3, wherein the step of managing the advertisements further comprises the step of providing instructions to the third party systems to disable one or more, but not all, of the advertisements based upon the rule accepted from the user.

5. The method of claim 3, wherein the rule comprises instructions to disable one or more advertisements based upon the occurrence of one or more future events.

6. The method of claim 1, wherein the third party systems provide the advertisements indirectly to end users via one or more networked computer systems.

7. The method of claim 1, wherein the advertisements are provided to end users through web browsers.

8. The method of claim 1, wherein the step of accepting only one or more titles, one or more URLs, and one or more images is provided from the user via a single web page.

9. A method of distributing content over the interne comprising the steps of:
generating content, where generating content comprises the steps of accepting one or more strings, one or more uniform resource locators (URLs), and one or more images; and combining the strings, URLs, and images to create the content, where the content comprises a plurality of individual content items;
distributing the content to a plurality of third party systems, where the third party systems provide the content to end users;
managing the content; where managing the content comprises the steps of harvesting data from the plurality of third party systems; synthesizing the data to provide results for the individual content items; and providing the synthesized data to the user.

10. The method of claim 9, wherein the step of generating content further comprises the step of providing the content to a user for previewing.

11. The method of claim 9, wherein the step of managing the content further comprises the step of providing instructions to the third party systems to disable one or more, but not all, of the individual content items.

12. The method of claim 9, wherein the step of managing the content further comprises the step of accepting a rule from the user.

13. The method of claim 12, wherein the step of managing the content further comprises the step of providing instructions to the third party systems to disable one or more, but not all, of the individual content items based upon the rule accepted from the user.

14. The method of claim 12, wherein the rule comprises instructions to disable one or more individual content items based upon the occurrence of one or more future events.

15. The method of claim 9, wherein the third party systems provide the content indirectly to end users via one or more networked computer systems.

16. The method of claim 9, wherein the content is provided to end users through web browsers.

17. The method of claim 9, wherein the step of accepting only one or more strings, one or more URLs, and one or more images is provided from the user via a single web page.

18. A system for generating, distributing, and managing advertisements distributed through third party systems comprising:
an advertisement generation subsystem, where the advertisement generation subsystem comprises computer readable instructions for accepting one or more titles, one or more uniform resource locators (URLs), and one or more images; combining the titles, URLs, and images to create advertisements; and providing the advertisements to a user for previewing;
an advertisement distribution subsystem, where the advertisement distribution subsystem comprises computer readable instructions for distributing the advertisements to a plurality of third party systems;
an advertisement management subsystem, where the advertising management subsystem comprises computer readable instructions for harvesting data from the third party systems; synthesizing the data to provide results for individual advertisements; and providing the synthesized data to the user.

19. The system of claim 18, wherein the advertisement management subsystem further comprises computer readable instructions for accepting a rule from the user, and providing instructions to the third party systems to disable one or more, but not all, of the advertisements based upon the rule accepted from the user.

20. The system of claim 18, wherein the advertisement generation subsystem further comprises computer readable instructions for providing a single webpage through which the user can provide the one or more titles, one or more URLs, and one or more images, wherein the webpage comprises instructions for accepting inputs and creating objects, where each object comprises multiple vectors, where each vector comprises a URL, title, and image.
